(19) United States
(12) Patent Application Publication
(10) Pub. No.: US 2024/0414448 A1
(43) Pub. Date: Dec. 12, 2024

(54) EFFICIENT ON-DEVICE TRANSFORMER ARCHITECTURE FOR IMAGE PROCESSING

(71) Applicant: SAMSUNG ELECTRONICS CO., LTD., Suwon-si (KR)

(72) Inventors: Karim AHMED, San Jose, CA (US); Yi WEI, Sunnyvale, CA (US); Vasili RAMANISHKA, Mountain View, CA (US); Yilin SHEN, San Jose, CA (US); Hongxia JIN, San Jose, CA (US)

(73) Assignee: SAMSUNG ELECTRONICS CO., LTD., Suwon-si (KR)

(21) Appl. No.: 18/515,732

(22) Filed: Nov. 21, 2023

Related U.S. Application Data
(60) Provisional application No. 63/471,727, filed on Jun. 7, 2023.

(51) Int. Cl. H04N 23/84; G06T 3/4015; G06T 5/60; G06T 5/70

(52) U.S. Cl. CPC H04N 23/843; G06T 3/4015; G06T 5/60; G06T 5/70; G06T 2207/10024; G06T 2207/20081

(57) ABSTRACT

Provided is a U-shaped network for image restoration. The U-shaped network is lightweight based on a transformer block and is suitable to be deployed on-device, such as in a smartphone. The U-shaped network uses the transformer block to implement encoder, decoder and bottleneck functions. Decoders are connected to respective encoders using skip connections based on element-wise addition, which avoids dimension expansion of concatenation. The transformer block uses a configuration of scaling and pool mixing to process input image data without the need for self-attention computations which permits reduction in memory, reduction in latency, reduction in computational demand, all while maintaining good output image quality.

### CROSS REFERENCE TO RELATED APPLICATION(S)

This application claims benefit of priority to U.S. Provisional Application No. 63/471,727 filed in the USPTO on Jun. 7, 2023. The content of the above application is hereby incorporated by reference.

### FIELD

This application is related to an on-device image signal processor (ISP) pipeline using a deep learning model to perform image processing and restoration.

### BACKGROUND

Some camera ISP pipelines integrate deep learning models to address various image processing and restoration tasks, such as image demosaicing (raw-to-RGB processing) and denoising. Using deep learning architectures for high-resolution cameras presents challenges. This is due to high latency and memory consumption of deep learning architectures when processing high resolution images.

### SUMMARY

In one embodiment, a U-shaped lightweight transformer-based architecture that reduces the inter-block and intra-block system complexity is used to perform image restoration (e.g., demosaicing and denoising) on-device. In some embodiments, transformer blocks of the architecture do not include a self-attention computation.

The proposed model works efficiently with high resolution cameras and minimizes latency and memory usage while maintaining the quality of the output images. The proposed architecture of the model enables it to learn more effectively from image data, resulting in high-quality results with faster and more convenient image processing. Current state-of-the-art image restoration and processing models suffer from high intra-block (within a transformer) and inter-block system (across a U-shaped network) complexity.

A transformer is one building block used in image restoration architectures. Intra-block-complexity refers to the complexity of the transformer block. A conventional transformer block uses self-attention. Self-attention can be regarded as input/token mixer, with quadratic computational complexity with respect to the input size. A self-attention block is often followed or preceded by downsampling or upsampling convolutional layers which require expensive input and output reshaping operations from and to 4D (batch size B, channels C, height H, width W) to and from 3D (B, H*W, C). An optimized on-device implementation for self-attention may not exist while optimized on-device implementations of convolutional layers do exist. Transformer blocks of the present application do not include the self-attention function.

A U-shaped architecture is useful in image processing and restoration models. The U-shaped architecture generally has high inter-block system complexity due to high runtime memory usage partially caused by the concatenation of skip connections between encoder and decoder blocks. Also, the latency increases as the depth (number of encoder/decoder blocks in each stage) increases.

In some embodiments, a smartphone comprises a camera app; a user interface; and custom hardware and/or a CPU. The custom hardware and/or CPU is configured to receive an input image from the camera app, and operate on the input image using a U-shaped hierarchical network to produce an output image. An encoder of the U-shaped hierarchical network contributes to a decoder of the U-shaped hierarchical network using a skip connection based on element-wise addition. Each encoder and decoder block includes a pooling input mixer followed by a first channel scaler, and a multi-layer perceptron followed by a second channel scaler. The custom hardware and/or the CPU is also configured to transmit the output image to the camera app for display on the user interface.

Provided herein is an apparatus for image restoration, the apparatus including: one or more memories storing instructions; and one or more processors configured to execute the instructions to at least: operate on an input image using a U-shaped network to produce an output image, wherein an encoder of the U-shaped network contributes to a decoder of the U-shaped network using a skip connection based on element-wise addition, the encoder is a first instance of a transformer block, the decoder is a second instance of the transformer block, and the transformer block includes: a pooling input mixer followed by a first channel scaler, and use a multi-layer perceptron followed by a second channel scaler.

Also provided herein is a smartphone including: a camera app; a user interface; and an application specific integrated circuit, wherein the application specific integrated circuit is configured to at least: receive an input image from the camera app, operate on the input image using a U-shaped network to produce an output image, wherein an encoder of the U-shaped network contributes to a decoder of the U-shaped network using a skip connection based on element-wise addition, wherein the encoder is a first instance of a transformer, the decoder is a second instance of the transformer and the transformer includes a pooling input mixer followed by a first channel scaler, and a multi-layer perceptron followed by a second channel scaler, and transmit the output image to the camera app for display on the user interface.

Also provided is a method using a U-shaped network, the method including: projecting an input image to obtain a projected input image; processing the projected input image through a plurality of encoders and a plurality of decoders to obtain a last decoder output, wherein the last decoder output is an output of a last decoder; and projecting the last decoder output to obtain an output image, wherein the plurality of encoders includes a first encoder, the plurality of decoders includes the last decoder, the method further includes: processing, by the first encoder, the projected input image in part using a pooling input mixer, and feeding, by the first encoder, an intermediate feature vector to an input of the last decoder using a skip connection, wherein the skip connection is based on element-wise addition using a summation node associated with the skip connection.

Also provided is a second smartphone including: a camera app; a user interface; and the apparatus for image restoration; wherein the instructions are further configured to cause the one or more processors to: receive the input image from the camera app; and transmit the output image to the camera app for display on the user interface.

### BRIEF DESCRIPTION OF THE DRAWINGS

The text and figures are provided solely as examples to aid the reader in understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of embodiments provided herein.

FIG. 1A illustrates logic of a U-shaped network, deployed on a device, which performs image restoration with low latency, low memory and good quality, according to some embodiments.

FIG. 1B illustrates logic of the U-shaped network, deployed on a device, using skip connections with element-wise addition, according to some embodiments.

FIG. 2A illustrates a first comparison of demosaicing of input images showing the benefit of the U-shaped network, according to an example.

FIG. 2B illustrates a second comparison of demosaicing of input images showing the benefit of the U-shaped network, according to an example.

FIG. 3A shows an example transformer block, according to an example embodiment.

FIG. 3B shows details of the transformer block of FIG. 3A, according to some embodiments.

FIG. 4 shows the U-shaped network using the transformer block of FIG. 3B, according to an example embodiment.

FIG. 5 illustrates an example of batch normalization used in the transformer block of FIG. 3B.

FIG. 6 illustrates details of a multilayer perceptron (MLP) used in the transformer block of FIG. 3B.

FIG. 7A, FIG. 7B and FIG. 7C illustrates the transformer block of FIG. 3B used as an encoder, a decoder and a bottleneck, respectively.

FIG. 8 illustrates exemplary hardware for implementation of computing devices for implementing the systems and algorithms described by the figures, according to some embodiments.

### DETAILED DESCRIPTION

Embodiments provide an efficient transformer U-shaped network architecture. The efficiency is achieved at both the transformer block level and at the system level.

The efficient transformer blocks are used as encoders and decoders in the U-shaped network. The architecture is hierarchical. The architecture performs feature fusion using element-wise addition. The use of element-wise addition avoids the dimensionality expansion of concatenation used in other ISP architectures. The feature fusion at skip connections fuses feature maps between the encoders and decoders using the element-wise addition; element-wise addition rather than concatenation reduces runtime memory requirements. The U-shaped network of embodiments tends to increase the width (number of feature channels) and decrease the depth. This reduces latency while maintaining good accuracy.

The transformer block (foundation of the encoder blocks, the decoder blocks and the bottleneck block), uses components in an innovative way to reduce memory, reduce latency and maintain image quality results of the U-shaped network. The components include batch normalization, a pooling input mixer, a channel scaler, and a multi-layer perceptron (MLP).

The batch normalization, during inference, uses moving average statistics calculated during the training process from batches. The batch normalization acts as a linear transformation which can be folded into other preceding linear transformation layers such as convolutional layers. This structural optimization is known as batch normalization folding. The batch normalization is latency-favorable on GPU hardware compared to a layer normalization coupled to a self-attention.

The pooling input mixer is implemented as a pooling layer in which the output shape is equal to the input shape. The pooling input mixer has linear complexity with respect to size. The pooling input mixer does not require input reshaping (compared to a self-attention layer) and this contributes to the latency reduction. The pooling input mixer does not include trainable parameters, and this reduces memory usage.

A channel scaler is included in the transformer block in two places: after the pooling input mixer and after the MLP. The channel scaler is a lightweight layer used to scale each channel with learnable parameters. A learnable parameter may also be referred to as a trainable parameter. Without the channel scaler, the omission of self-attention would cause a performance drop. That is, the channel scaler mitigates this performance drop due to using a simple pooling input mixer instead of self-attention. The channel scaler mitigates the performance drop without a significant increase in latency and without a significant increase in memory.

An MLP is included in the transformer block. The MLP is implemented efficiently with convolutions (with 4D input shape and 4D output shape).

An example use case of the U-shaped network is converting raw images captured by high-resolution phone cameras or other devices to RGB images. This conversion, in some embodiments, includes demosaicing.

In performing a benchmark demosaicing operation with an input size of 1024×1024, embodiments reduce required GMACs (1 GMAC is 1 billion multiply and accumulates) from an order of 200 to an order of 10, reduce a number of trainable parameters from about 30 million to about 1 million, reduce a memory requirement from an order of 800 million bytes to 100 million bytes, reduce a latency from an order of 270 ms (milliseconds) to an order of 30 ms and increase PSNR in a first benchmark from 40 to about 42 dB and increase PSNR in a second benchmark from about 45 dB to about 51 dB.

A second example use of the U-shaped network is denoising of raw or RGB images captured by high-resolution cameras.

In performing a benchmark denoising, embodiments reduce required GMACs from an order of 44 to an order of 15, reduce a number of learnable parameters from an order of 20 to an order of 10, reduce latency on a server GPU from an order of 90 to an order of 11, and increase PSNR from 39.77 to 39.79 (about the same PSNR).

Also provided herein is a non-transitory computer readable medium storing instructions configured to cause one or more processors to: operate on an input image using a U-shaped network to produce an output image, wherein an encoder of the U-shaped network contributes to a decoder of the U-shaped network using a skip connection based on element-wise addition, the encoder is a first instance of a transformer block, the decoder is a second instance of the transformer block, and wherein the transformer block comprises: a pooling input mixer followed by a first channel scaler, and use a multi-layer perceptron followed by a second channel scaler.

Embodiments of the application will now be described with the aid of the drawings.

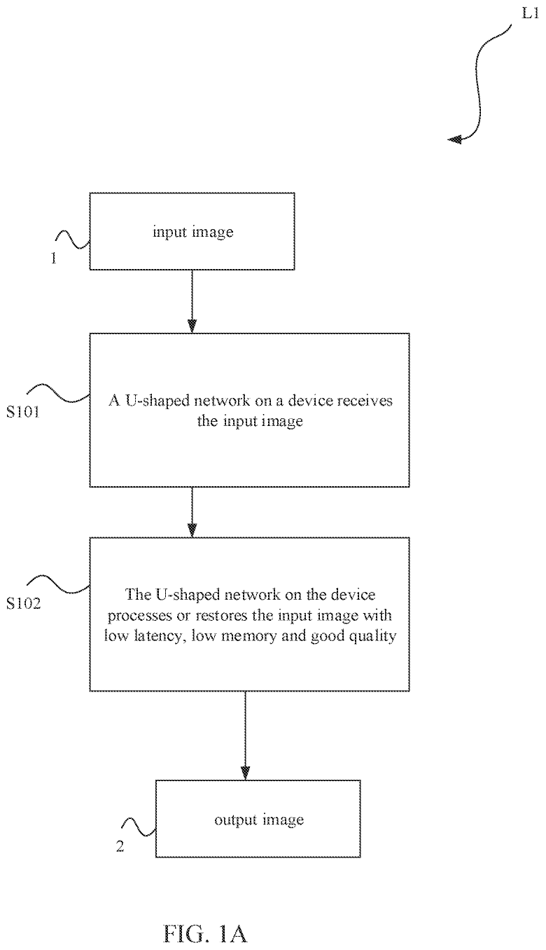

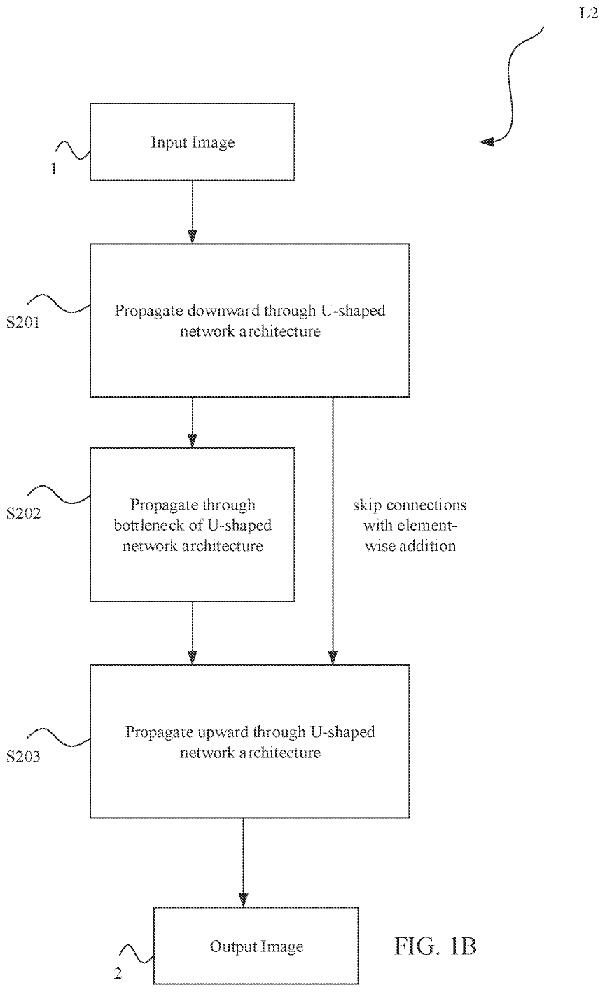

FIG. 1A illustrates logic L1 for processing an input image 1 and obtaining an output image 2. At operation S101, the U-shaped network on a device such as a smartphone receives the input image 1. At operation S102, the U-shaped network processes or restores the input image 1. The U-shaped network achieves this restoration of the image 1 with low latency, low memory and good quality as mentioned with quantitative examples above.

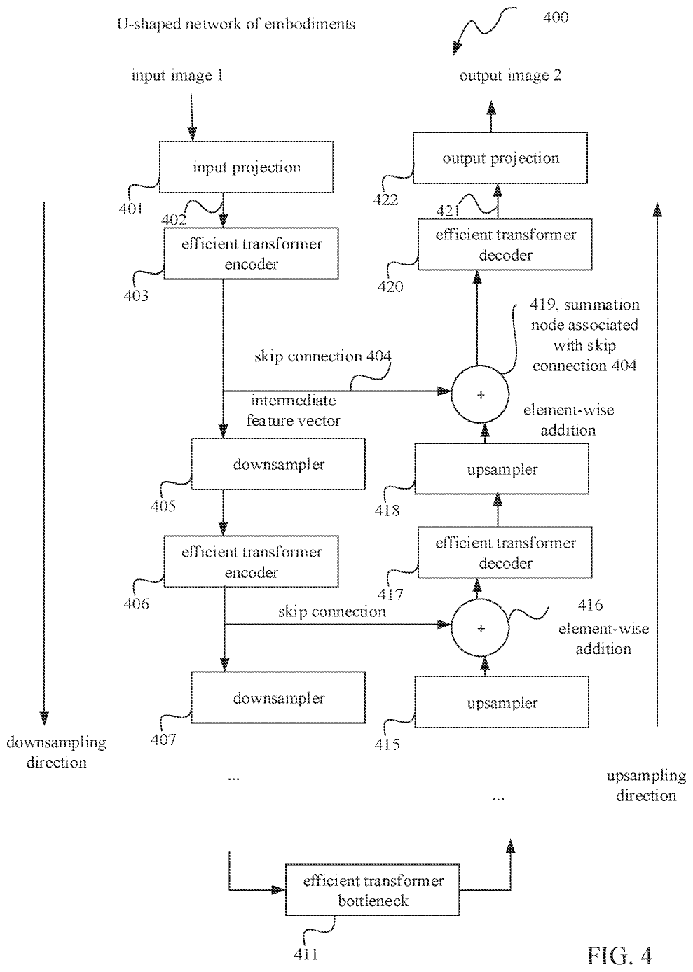

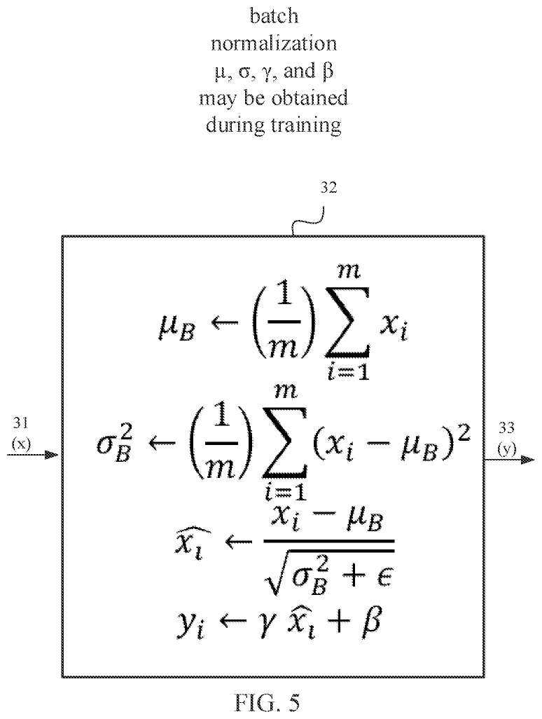

FIG. 1B illustrates logic L2 with additional details with respect to FIG. 1A. An example of the U-shaped network is shown in FIG. 4 (item 400). The operations of L2 generally occur concurrently, as can be seen with reference to the flow in FIG. 4. Referring again to FIG. 1B, at operation S201, the input image 1 is propagated downward through the U-shaped network 400. Concurrently with this, at operation S102, data based on the flow of the image through the encoders is processed by the bottleneck (see FIG. 4, item 411). Concurrent with operations S101 and S103, operation S103 propagates data upward through the U-shaped network 400. Date from the encoders contributes to the upward propagating data based on skip connections using element-wise addition. The element-wise addition, compared to fusion by concatenation, controls the dimension of the data, limits memory requirements and limits computational demand. The data propagating upward through the last portion of the U-shaped network 400, see item 422 of FIG. 4, provides the output image 2.

In some embodiments, image restoration is that of a raw to RGB demosaicing. A demosaicing algorithm is a digital image process used to reconstruct a full color image from the incomplete color samples output from an image sensor. In some embodiments, the image sensor is a Bayer-pixel-layout image sensor. A demosaic error is the difference between a noiseless ground truth RGB image and the output image.

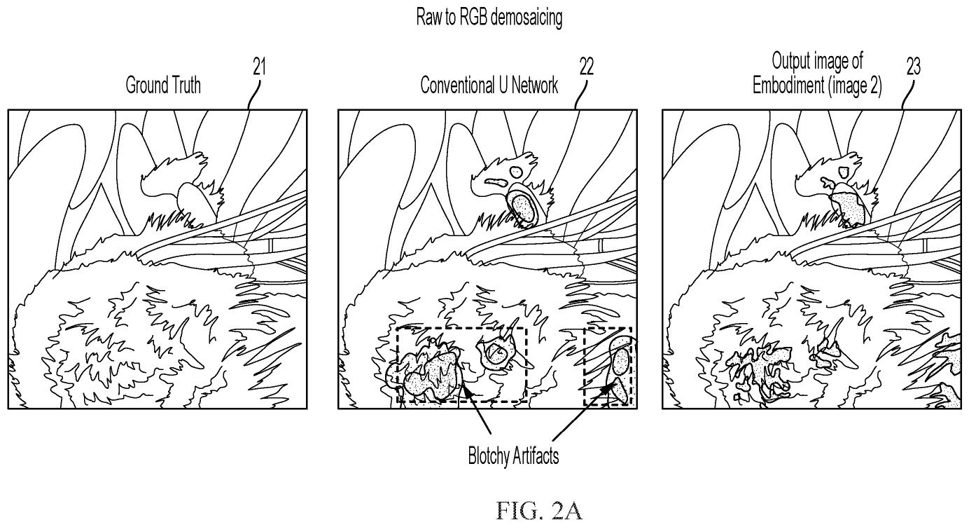

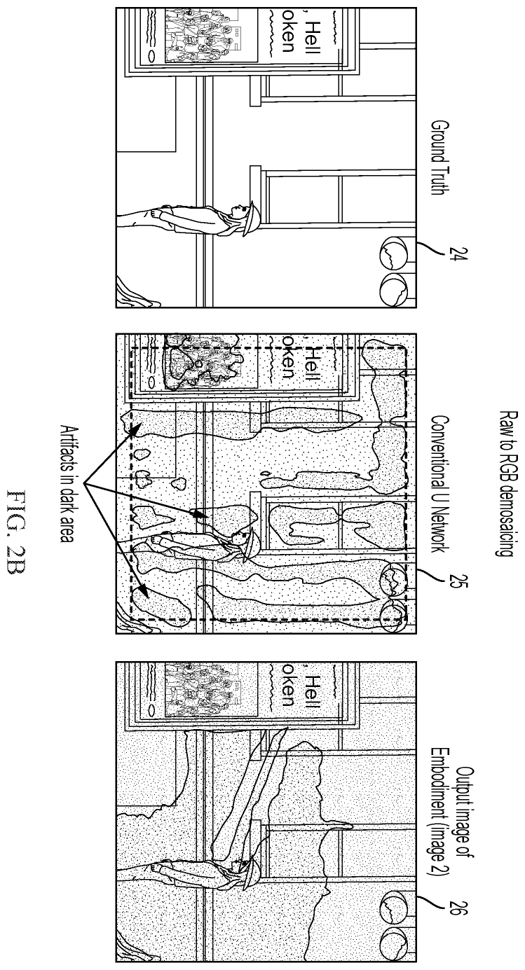

FIG. 2A illustrates a comparison of image restoration of an image of a honeybee. Ground truth is shown on the left (item 21). In the center, a result of a demosaic operation by a conventional U network using self-attention and concatenation is shown (item 22). Blotchy artifacts occur as shown by the arrows in FIG. 2A. On the right is an example of output image 2 of embodiments (item 23). The artifacts do not occur in output image 2 (item 23) using the U-shaped network 400 of FIG. 4.

FIG. 2B illustrates a second comparison of image restoration. The image shows part of a poster on a dark shadowy wall. Ground truth is shown on the left (item 24). In the center, a result of a demosaic operation by a conventional U network using self-attention and concatenation is shown (item 25). Artifacts occur in dark areas as shown by the arrows in FIG. 2B. On the right is an example of output image 2 of embodiments (item 23). The artifacts do not occur in output image 2 (item 26) using the U-shaped network 400 of FIG. 4.

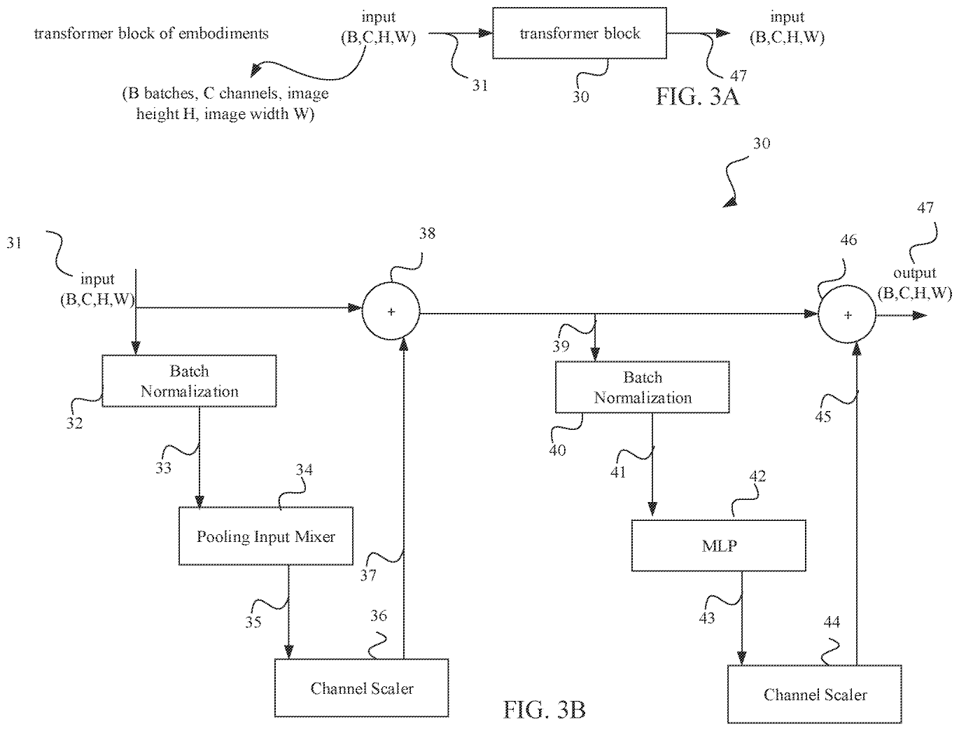

Description of embodiments is provided in FIG. 3B at the block level (FIG. 3A). Description at the network level is provided below in the discussion of FIG. 4.

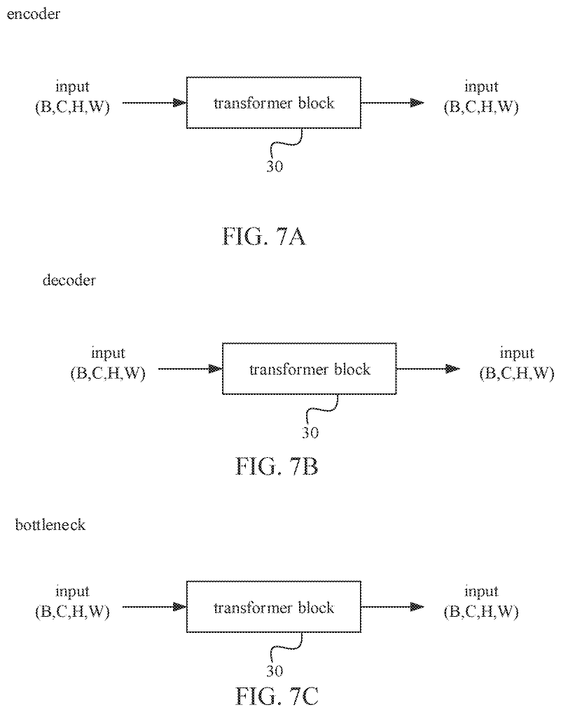

In FIGS. 3A, 3B and 7A-7C, the 4-tuple (B,C,H,W) refers to (batch size B, channels C, height H and width W).

As shown in FIG. 3A, the 4-tuple (B,C,H,W) is the same at the input and the output of the transformer block 30. The same is true for FIG. 3B, which provides the details of FIG. 3A (see items 31 and 47 identifying the input and output of transformer block 30).

The U-shaped network 400 is formed, in part, of encoders, decoders and a bottleneck. Each encoder, each decoder and the bottleneck is an instance of the transformer block 30 (see FIGS. 7A, 7B and 7C). The U-shaped network 400 also includes an input projection 401 (see FIG. 4) and an output projection 422 (see FIG. 4).

FIG. 3B provides the details of transformer block 30.

The input 31 of a transformer block 30 is coupled to a batch normalization 32 (see FIG. 5) and a summation node 38. The output 33 of the batch normalization 32 is input to a pooling input mixer 34. The output 35 of the pooling input mixer 34 is input to a channel scaler 36. The output 37 of the channel scaler 36 is fed to the summation node 38 and the output 39 of the summation node 38 is fed to batch normalization 40 and to summation node 46.

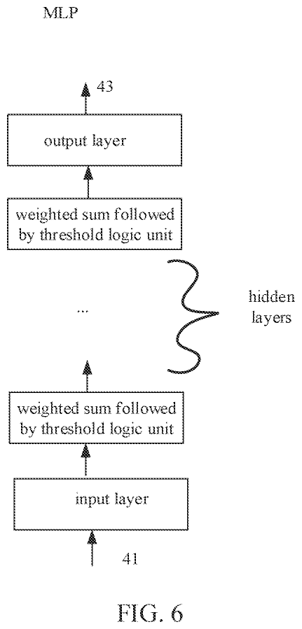

The output 41 of the batch normalization 40 is fed to the MLP 42 (see FIG. 6) and the output 43 of the MLP 42 is fed to channel scaler 44. The output 45 of the channel scaler 44 is fed to summation node 46 which provides output 47, the output of transformer block 30.

FIG. 4 illustrates details of the U-shaped network 400.

FIG. 4 includes transformer blocks. The transformer blocks of embodiments do not include self-attention.

Input image 1 is processed by input projection 401 to obtain output 402. Output 402 is processed by an instance of transformer block 30, here denoted as efficient transformer encoder 403. The output 404 passes by a skip connection to summation node 419. The output 404 also is downsampled by downsampler 405. Downsampler 405, in an example, is implemented by a two-dimensional convolutional layer with kernel size=4, stride=2, and the number of output channels=2×number of input channels. Signals propagate downward in the downsampling direction to further layers of transformer blocks, skip connections and downsamplers (see items 406 and 407 in FIG. 4). The number of layers in the U-shaped network 400, in an example embodiment, includes 4 encoder blocks each followed by 1 a downsampling layer, 1 bottleneck block followed by an upsampling layer, and 4 decoder blocks each followed by an upsampling layer.

After the lowermost downsampler, data is processed by an instance of transformer block 30 denoted in FIG. 4 as efficient transformer bottleneck 411. The output of the bottleneck the flows upward in the upsampling direction as shown in FIG. 4, passing through an upsampler 415, an element-wise addition 416, a transformer block 30 denoted as efficient transformer decoder 417, and an upsampler 418. Upsampler 418 may be implemented by a two-dimensional convolutional layer with (as non-limiting examples) kernel size=2, stride=2, and the number of output channels=0.5×number of input channels. The upsampler 418 feeds the summation node 419 which produces output 421. The output 41 passes through an output projection 422 to produce output image 2.

As a review of FIGS. 1A-5, embodiments include an apparatus for image restoration, the apparatus comprising: one or more memories storing instructions; and one or more processors configured to execute the instructions to at least: operate on an input image (FIG. 4, input image 1) using a U-shaped hierarchical network (FIG. 4 item 400) to produce an output image (FIG. 1 item S101, FIG. 2A item 23, FIG. 2B item 26), wherein an encoder (FIG. 4 item 403, FIG. 3A item 30, FIG. 7A) of the U-shaped hierarchical network contributes to a decoder (FIG. 4 item 420, FIG. 3A item 30, FIG. 7B) of the U-shaped hierarchical network using a skip connection (FIG. 4 item 404) based on element-wise addition (FIG. 4 item 419), the encoder (for example item 403) is configured to a first instance of a transformer block (item 30), the decoder (for example, item 420) is a second instance of the transformer block (item 30), and the transformer block (item 30) comprises: a pooling input mixer (FIG. 3B item 34) followed by a first channel scaler (FIG. 3B items 36 and 44), and a multi-layer perceptron (item 42 and FIG. 6) followed by a second channel scaler (item 44).

In some embodiments, the pooling input mixer (item 34) doesn't comprise learnable parameters.

In some embodiments, an input shape (B,C,H,W) of the pooling input mixer (item 34) is equal to an output shape (B,C,H,W) of the pooling input mixer.

In some embodiments, the U-shaped network (item 400) does not apply concatenation to the skip connection (item 404) thereby reducing latency of the apparatus by avoiding a dimensionality expansion.

In some embodiments, the pooling input mixer (item 34) is preceded in the transformer block (item 30) by a batch normalization (item 32), and the batch normalization is configured to be foldable into a preceding linear transformation.

In some embodiments, the transformer block (item 30) comprises a first stage (items 32, 34, 36 and 38) and a second stage (items 40, 42, 44 and 46), the first stage comprises a first batch normalization (item 32), the pooling input mixer (item 34), the first channel scaler (item 36), and a first summation node (item 38), wherein the first summation node operates on an input to the transformer block (30) and an output of the first channel scaler (36), and the second stage comprises a second batch normalization (item 40), the multi-layer perceptron (item 42) followed by the second channel scaler, and a second summation node (item 46), wherein the second summation node operates on an output of the first summation node and an output of the second channel scaler to produce an output of the transformer block (item 30).

Based on the configuration and structure of the U-shape network 400, a latency of the apparatus is reduced by achieving a batch normalization which is latency-favorable on GPU hardware, a memory footprint is reduced by avoiding concatenation at the skip connection, and the avoiding concatenation allows a computation of a layer output to have a reduced latency by avoiding an increase in array dimensions.

In some embodiments, a first decoder (item 420) at a same level of the U-shaped network (400) as a first encoder (item 403) is identical to the first encoder other than learned parameters.

Also, based on FIGS. 4 and 11, embodiments include a smartphone (119) comprising: a camera app (120); a user interface (115); and an application specific integrated circuit (118), wherein the application specific integrated circuit is configured to at least: receive an input image (input image 1) from the camera app, operate on the input image using a U-shaped network (item 400) to produce an output image (output image 2), wherein an encoder of the U-shaped network contributes to a decoder of the U-shaped network using a skip connection based on element-wise addition, wherein the encoder is a first instance of a transformer (item 30), the decoder is a second instance of the transformer and the transformer comprises a pooling input mixer (item 34) followed by a first channel scaler (item 36), and a multi-layer perceptron (item 42) followed by a second channel scaler (item 44), and transmit the output image to the camera app for display on the user interface.

Also discloses is a method (FIGS. 1A and 1B) using a U-shaped network, the method comprising: projecting an input image (input image 1) to obtain a projected input image; processing the projected input image through a plurality of encoders (for example items 403 and 405) and a plurality of decoders (for example items 420 and 417) to obtain a last decoder output (item 421), wherein the last decoder output is an output of a last decoder (item 420); and projecting (item 422) the last decoder output to obtain an output image, wherein the plurality of encoders comprises a first encoder (item 403), the plurality of decoders comprises the last decoder (item 420), the method further comprises: processing, by the first encoder, the projected input image in part using a pooling input mixer (item 34), and feeding, by the first encoder, an intermediate feature vector (see item 404) to the last decoder using a skip connection (item 404), wherein the skip connection is based on element-wise addition using a second summation node (item 419).

In some embodiments, the first encoder comprises a transformer, the method further comprising performing, by the first encoder, a first batch normalization (item 32 and FIG. 5) of the projected input image to obtain a first batch normalization output, wherein the intermediate feature vector is based in part on the first batch normalization output.

In some embodiments, the method further includes performing, by the first encoder, a pooling input mixer operation (item 34) on the first batch normalization output to obtain a pooling input mixer output, wherein the intermediate feature vector is based in part on the pooling input mixer output.

In some embodiments, the method further includes performing, by the first encoder, a first channel scaling operation (item 36), wherein the first channel scaling operation is on the pooling input mixer output to obtain a first channel scaler output, wherein the intermediate feature vector is based in part on the first channel scaler output.

In some embodiments, the method further includes providing the first channel scaler output to a first summation node to obtain a first summation value; providing the first summation value to the second summation node (see items 39 and 46); performing, by the second summation node, the element-wise addition to obtain a second summation value (item 47); and providing the second summation value as an input to the last decoder (item 420).

In some embodiments, the method further includes performing, by the first encoder, a second batch normalization (item 40) of the first summation value (item 39) to obtain a second batch normalization output (item 41), wherein the intermediate feature vector is based in part on the second batch normalization output.

In some embodiments, the method further includes performing, by the first encoder, a multilayer perceptron (MLP) operation (item 42) on the second batch normalization output (item 41) to obtain an MLP output, wherein the intermediate feature vector is based in part on the MLP output.

In some embodiments, the method further includes performing, by the first encoder, a second channel scaling operation (item 44), wherein the second channel scaling operation is on the MLP output (item 43) to obtain a second channel scaler output, wherein the intermediate feature vector is based in part on the second channel scaler output.

In some embodiments, the method further includes performing the element-wise addition (see item 419) comprises summing, in element-wise fashion, the second channel scaler output (see the intermediate feature vector output from item 403) with an upsampler (item 418) output to provide an input to the last decoder (item 420).

In some embodiments, the input image has a resolution of 1024 by 1024 pixels, the method performing a demosaicing as a restoration of the input image requires approximately 10 billion multiply and accumulates, a latency of the restoration is approximately 30 milliseconds and a signal to noise ratio of the output image is approximately 42 dB.

In some embodiments, a number of trainable parameters in the U-shaped network is about 1 million.

Further details of blocks within transformer block 30 are shown in FIGS. 5-8.

FIG. 5 illustrates an exemplary batch normalization block. Input 31 is denoted generically as variable x and output 3 is denoted generically as variable y. Parameters (μ, σ, γ, β) are obtained from batch statistics during training. Conventional approaches do not permit folding of linear operations, as mentioned above.

The pooling input mixer 34, as an example, may be implemented by a two-dimensional average pooling layer with kernel size=3 and padding=1, except in the first two encoder blocks and the last two decoder blocks where it may be implemented by a two-dimensional maximum pooling layer size=3 and padding=1.

The channel scaler layer, as an example, may be implemented using a vector of trainable parameters of a size equal to the input channels dimension and initialized by a user-defined value before training. The output of the channel scaler layer is the element-wise multiplication of the parameters by the input feature maps over the channel dimension.

FIG. 6 illustrates a multilayer perceptron (MLP). The MLP includes, from the bottom, an input layer which accepts input 41. The input layer is followed by hidden layers. Each hidden layer includes a weighted sum followed by a threshold logic unit such as an ReLU. The output of the uppermost hidden layer serves as input to an output layer. The output layer provides the output 43. Further details of the construction of an MLP are well known in the art.

FIG. 7A illustrates transformer block 30 serving as an encoder.

FIG. 7B illustrates transformer block 30 serving as a decoder.

FIG. 7C illustrates transformer block 30 serving as a bottleneck.

The only parameterization which is needed in FIGS. 7A, 7B and 7C is to use the 4-tuple (B,C,H,W) appropriate for the level the U-shaped network in which the encoder, decoder or bottleneck occurs. In some embodiments, the only differences between the blocks of FIGS. 7A, 7B and 7C are in the values of C, H, and W.

The input projection 401 is a convolutional layer. The input projection projects the input features into feature maps with D (a hyper-parameter set by the user) channels. In some embodiments, the input projection layer is implemented by a two-dimensional convolutional layer.

Output projection 422 is realized by a convolutional layer. The output projection projects the feature maps output from the last decoder into the output features, with number of channels equal to the number of input image channels.

The trainable parameters of the U-shaped network 400 are trained offline before deployment in the device, such as a smartphone.

Training is performed, for example, using supervised learning using backpropagation given batches of raw data images and corresponding ground truth restored images.

Trainable parameters exist in the batch normalization instances, the channel scaler instances, the MLP instances, the input projection 401, the output projection 422, the downsampler layers and the upsampler layers.

Training is done by initially estimating the number of layers to use in the U-shaped network 400 and creating the artificial intelligence machine 400 by training over data sets. The performance of the resulting U-shaped network 400 is then compared with goals and constraints. If the goals are met and the constraints are not violated, the design is complete. Otherwise, adjustments are made to the number of batches B, the number of channels C, the number of layers in FIG. 4, etc. and the network is again trained followed by goal and constraint checking. This process is repeated until the goals are met and the constraints are not violated. The final network model (U-shaped network 400) is then deployed in devices such as smart phones. Examples of restoration using the trained U-shaped network 400 are shown in FIGS. 2A (item 23) and 2B (item 26).

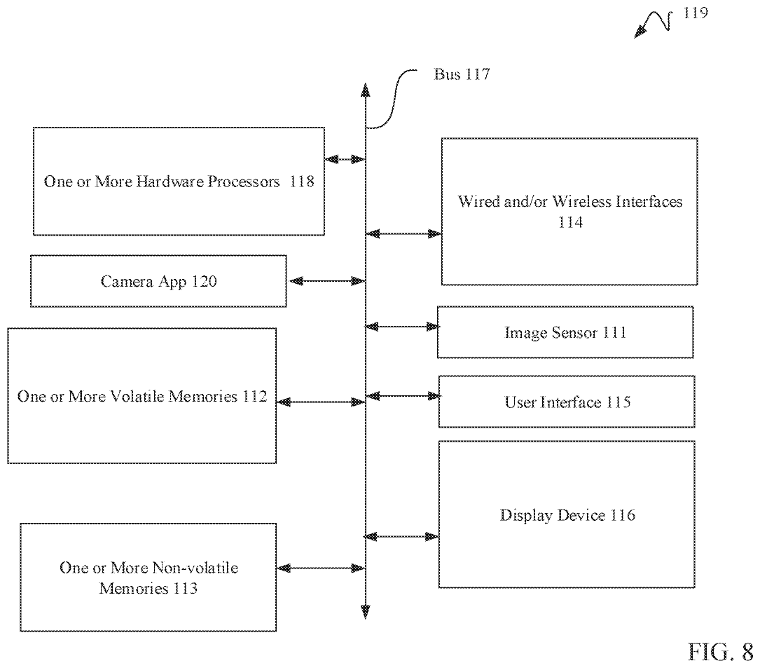

Hardware for performing embodiments provided herein is now described with respect to FIG. 8. FIG. 8 illustrates an exemplary apparatus 119 for implementation of the embodiments disclosed herein. The apparatus 119 may be a server, a computer, a laptop computer, a handheld device, or a tablet computer device, for example. Apparatus 119 may include one or more hardware processors 118. The one or more hardware processors 118 may include an ASIC (application specific integrated circuit), CPU (for example CISC or RISC device), and/or custom hardware. Embodiments can be deployed on various GPUs.

Embodiments may be deployed on various computers, servers or workstations.

Apparatus 119 also may include a user interface 115 (for example a display screen and/or keyboard and/or pointing device such as a mouse) and in image sensor 111. Apparatus 119 may include one or more volatile memories 112 and one or more non-volatile memories 113. The one or more non-volatile memories 113 may include a non-transitory computer readable medium storing instructions for execution by the one or more hardware processors 118 to cause apparatus 119 to perform any of the methods of embodiments disclosed herein.

In some embodiments, a smartphone including one or more processors includes a camera app; a user interface and the apparatus of FIG. 4. Instructions for implementing FIG. 4 in this embodiment are configured to cause the one or more processors to receive an input image 1 from the camera app, process the input image 1 using FIG. 4, and transmit the output image 2 from FIG. 4 to the camera app for display on the user interface.

What is claimed is:

1. An apparatus for image restoration, the apparatus comprising:
one or more memories storing instructions; and
one or more processors configured to execute the instructions to at least:
operate on an input image using a U-shaped network to produce an output image,
wherein an encoder of the U-shaped network contributes to a decoder of the U-shaped network using a skip connection based on element-wise addition,
the encoder is a first instance of a transformer block,
the decoder is a second instance of the transformer block, and
the transformer block comprises:
a pooling input mixer followed by a first channel scaler, and
use a multi-layer perceptron followed by a second channel scaler.

2. The apparatus of claim 1, wherein the pooling input mixer doesn't comprise learnable parameters.

3. The apparatus of claim 1, wherein an input shape of the pooling input mixer is equal to an output shape of the pooling input mixer.

4. The apparatus of claim 1, wherein the U-shaped network does not apply concatenation to the skip connection thereby reducing latency of the apparatus by avoiding a dimensionality expansion.

5. The apparatus of claim 1, wherein the pooling input mixer is preceded in the transformer block by a batch normalization, and the batch normalization is configured to be foldable into a preceding linear transformation.

6: The apparatus of claim 1, wherein the transformer block comprises a first stage and a second stage,
the first stage comprises a first batch normalization, the pooling input mixer, the first channel scaler, and a first summation node, wherein the first summation node operates on an input to the transformer block and an output of the first channel scaler, and
the second stage comprises a second batch normalization, the multi-layer perceptron followed by the second channel scaler, and a second summation node, wherein the second summation node operates on an output of the first summation node and an output of the second channel scaler to produce an output of the transformer block.

7. The apparatus of claim 1, wherein a latency of the apparatus is reduced by achieving a batch normalization which is latency-favorable on GPU hardware, a memory footprint is reduced by avoiding concatenation at the skip connection, and the avoiding concatenation allows a computation of a layer output to have a reduced latency by avoiding an increase in array dimensions.

8. The apparatus of claim 1, wherein a first decoder at a same level of the U-shaped network as a first encoder is identical to the first encoder other than learned parameters.

9. A smartphone comprising:
a camera app;
a user interface; and
an application specific integrated circuit, wherein the application specific integrated circuit is configured to at least:
receive an input image from the camera app,
operate on the input image using a U-shaped network to produce an output image, wherein an encoder of the U-shaped network contributes to a decoder of the U-shaped network using a skip connection based on element-wise addition, wherein the encoder is a first instance of a transformer, the decoder is a second instance of the transformer and the transformer comprises a pooling input mixer followed by a first channel scaler, and a multi-layer perceptron followed by a second channel scaler, and
transmit the output image to the camera app for display on the user interface.

10. A method using a U-shaped network, the method comprising:
projecting an input image to obtain a projected input image;
processing the projected input image through a plurality of encoders and a plurality of decoders to obtain a last decoder output, wherein the last decoder output is an output of a last decoder; and
projecting the last decoder output to obtain an output image,
wherein the plurality of encoders comprises a first encoder,
the plurality of decoders comprises the last decoder,
the method further comprises:
processing, by the first encoder, the projected input image in part using a pooling input mixer, and
feeding, by the first encoder, an intermediate feature vector to an input of the last decoder using a skip connection, wherein the skip connection is based on element-wise addition using a summation node associated with the skip connection.

11. The method of claim 10, wherein the first encoder comprises a transformer, the method further comprising performing, by the first encoder, a first batch normalization of the projected input image to obtain a first batch normalization output, wherein the intermediate feature vector is based in part on the first batch normalization output.

12. The method of claim 11, further comprising performing, by the first encoder, a pooling input mixer operation on the first batch normalization output to obtain a pooling input mixer output, wherein the intermediate feature vector is based in part on the pooling input mixer output.

13. The method of claim 12, further comprising performing, by the first encoder, a first channel scaling operation, wherein the first channel scaling operation is on the pooling input mixer output to obtain a first channel scaler output, wherein the intermediate feature vector is based in part on the first channel scaler output.

14. The method of claim 13, further comprising providing the first channel scaler output to a first summation node to obtain a first summation value;
providing the first summation value to a second summation node;
performing, by the second summation node, an addition to obtain a second summation value; and
providing, via the skip connection, the second summation value as an input to the summation node associated with the skip connection.

15. The method of claim 14, further comprising performing, by the first encoder, a second batch normalization of the first summation value to obtain a second batch normalization output, wherein the intermediate feature vector is based in part on the second batch normalization output.

16. The method of claim 15, further comprising performing, by the first encoder, a multilayer perceptron (MLP) operation on the second batch normalization output to obtain an MLP output, wherein the intermediate feature vector is based in part on the MLP output.

17. The method of claim 16, further comprising performing, by the first encoder, a second channel scaling operation, wherein the second channel scaling operation is on the MLP output to obtain a second channel scaler output, wherein the intermediate feature vector is based in part on the second channel scaler output.

18. The method of claim 17, wherein the performing the element-wise addition comprises summing, in element-wise fashion, the second channel scaler output with an upsampler output to provide the input to the last decoder.

19. The method of claim 18, wherein the input image has a resolution of 1024 by 1024 pixels, the method performing a demosaicing as a restoration of the input image requires approximately 10 billion multiply and accumulates, a latency of the restoration is approximately 30 milliseconds and a signal to noise ratio of the output image is approximately 42 dB, and, wherein a number of trainable parameters in the U-shaped network is about 1 million.

20. A non-transitory computer readable medium storing instructions configured to cause one or more processors to:
operate on an input image using a U-shaped network to produce an output image,
wherein an encoder of the U-shaped network contributes to a decoder of the U-shaped network using a skip connection based on element-wise addition,
the encoder is a first instance of a transformer block,
the decoder is a second instance of the transformer block, and wherein the transformer block comprises:
a pooling input mixer followed by a first channel scaler, and
use a multi-layer perceptron followed by a second channel scaler.
